(19) United States
(12) Patent Application Publication
(10) Pub. No.: US 2005/0287262 A1
(43) Pub. Date: Dec. 29, 2005

(54) Method and apparatus for producing and selling potato chips

(76) Inventors: Clyde Brett Hamilton, Warrenton, MO (US); Ed Pilla, Warrenton, MO (US)

Correspondence Address: GRACE J FISHEL, 11970 BORMAN DRIVE, SUITE 220, ST. LOUIS, MO, 63146, US

(21) Appl. No.: 11/192,256

(22) Filed: Jul. 28, 2005

Related U.S. Application Data
(63) Continuation of application No. 10/369,001, filed on Feb. 19, 2003.

(51) Int. Cl. A23L 1/00

(52) U.S. Cl. 426/438

(57) ABSTRACT

A method comprises slicing at least one raw potato via a slicing mechanism into a plurality of raw potato chips above a volume of heated oil in a manner such that gravity causes the raw potato chips to fall into the heated oil. The method further comprises converting the raw potato chips into deep-fried potato chips via the heated oil and removing the deep-fried potato chips from the heated oil. The steps of slicing, converting, and removing are performed automatically and constitute production of deep-fried potato chips. The method further comprises displaying the slicing and the removing steps to a potential consumer by direct line-of-sight to entice the potential consumer to purchase deep-fried potato chips. Additionally, the method comprises selling deep-fried potato chips to the consumer within fifty feet of the production of deep-fried potato chips.

### BACKGROUND OF THE INVENTION

Various mass meeting events or locations, such as conventions, carnivals, fairs, sporting events, musical events, amusement parks, and the like often have booths, kiosks, or counters for providing various food and beverage items to people attending such events or at such locations. This invention pertains to the production and sale food items at such events and locations.

### SUMMARY OF THE INVENTION

The present invention provides a method and apparatus for producing deep-fried potato chips and for marketing potato chips at meeting events or locations. Using the apparatus of the invention, the production of potato chips themselves becomes an attraction that entices consumers to purchase potato chips.

In a first aspect of the invention, a method of practicing the invention comprises the steps of producing deep-fried potato chips, displaying particular steps of the production to a potential consumer, and selling deep-fried potato chips to the consumer. The production of the deep-fried potato chips comprises slicing at least one raw potato via a slicing mechanism into a plurality of raw potato chips above a volume of heated oil in a manner such that gravity causes the raw potato chips to fall into the heated oil, converting the raw potato chips into deep-fried potato chips via the heated oil, and removing the deep-fried potato chips from the heated oil. The steps of slicing, converting, and removing are performed automatically. The step of displaying the production comprises displaying the slicing and the removing steps to a potential consumer to entice the potential consumer to purchase deep-fried potato chips and occurs by direct line-of-sight. Finally, the step of selling deep-fried potato chips to the consumer occurs within fifty feet of the production of deep-fried potato chips.

In a second aspect of the invention, a method of practicing the invention comprises the steps of providing a deep-fried potato chip production device, slicing a plurality of raw potatoes into a plurality of raw potato chips, and converting the raw potato chips into deep-fried potato chips. The production device provided comprises a slicing mechanism, a bath of heated oil, a strainer, and an electronic control unit. The slicing occurs over the bath of heated oil via the slicing mechanism. The slicing also occurs while the slicing mechanism and the plurality of raw potatoes are moving in a reciprocating manner relative to the bath of heated oil such that gravity causes the plurality raw potato chips to fall into the bath of heated oil in a dispersed manner. The moving of the slicing mechanism and the slicing are controlled by the control unit. The converting of the raw potato chips into deep-fried potato chips occurs via the bath of heated oil. The method also comprises removing the deep-fried potato chips from the bath of heated oil by raising the strainer out of the bath of heated oil. The raising of the strainer is also controlled by the control unit.

In yet another aspect of the invention, an apparatus comprises a cooking oil container, a heat source, a potato slicing mechanism, a strainer, and an electronic control unit. The cooking oil container contains a bath of cooking oil and the heat source is adapted to provide heat to the bath of cooking oil. The potato slicing mechanism is configured and adapted to slice raw potatoes and is operatively connected to the cooking oil container in a manner such that the potato slicing mechanism is capable of reciprocating movement relative to the bath of cooking oil. The strainer is operatively connected to the cooking oil container in a manner such that at least a portion of the strainer is movable into and out of the bath of cooking oil. The electronic control unit is operatively connected to the potato slicing mechanism and the strainer in a manner such that the electronic control unit is adapted to control the reciprocating movement of the potato slicing mechanism and the movement of the portion of the strainer.

While the principal advantages and features of the invention have been described above, additional features and advantages may be obtained by referring to the drawings and the detailed description of the preferred embodiment, which follow.

### BRIEF DESCRIPTION OF THE DRAWINGS

FIG. 1 is perspective view of a potato chip production device in accordance with the invention, the device being shown with a strainer in a lowest position and with a potato slicing mechanism in an intermediate position of reciprocation.

FIG. 2 is a perspective view of the potato chip production device shown in FIG. 1 and is shown with the slicing mechanism in a parked position and with the strainer in a raised position.

FIG. 3 is a perspective view of the potato chip production device shown in FIGS. 1 and 2 and is shown with the strainer pivoted in a position for the removal of potato chips therefrom.

Reference characters in the written specification indicate corresponding items shown throughout the drawing figures.

### DETAILED DESCRIPTION OF THE PREFERRED EMBODIMENT OF THE INVENTION

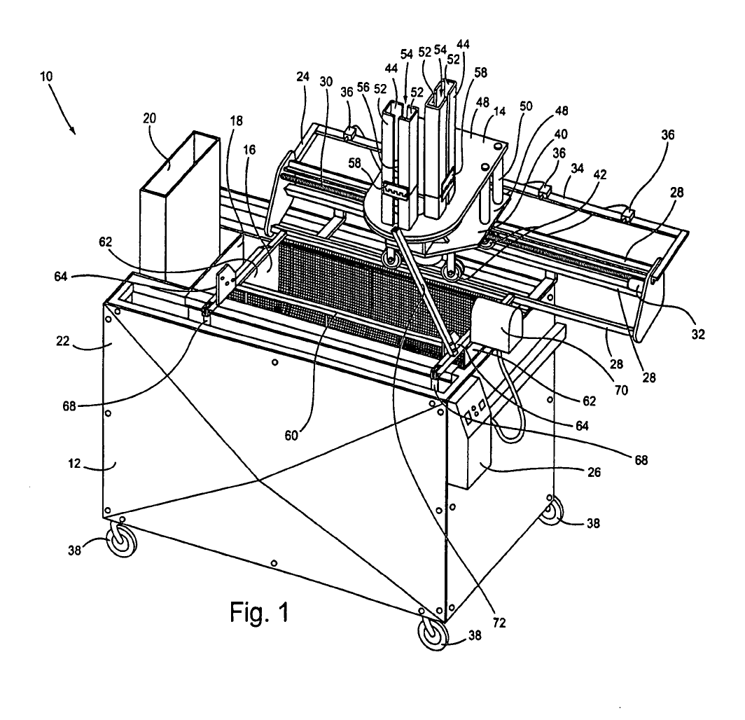

In accordance with the invention, a preferred embodiment of a potato chip production device is shown in FIGS. 1-3 and is generally indicated by the reference numeral 10. The potato chip production device 10 comprises a main body portion 12, a potato slicing mechanism 14, and a strainer 16.

The main body portion 12 of the of the potato chip production device 10 preferably has a boxed shaped frame assembly which contains and supports a cooking oil container 18, an internal heat source (not shown), and an exhaust plenum 20. The cooking oil container 18 is open on its top and is adapted to hold a relatively large bath of cooking oil for deep-frying potato chips therein. The heat source is preferably a propane burner positioned beneath the cooking oil container 18. The main body portion 12 is configured such that the combustion byproducts of the heat source are discharge through the exhaust plenum 20 and exit into the external environment at a sufficient height that avoids interfering with the operation of the rest of the production device 10. Due to the heat generated by the heat source and dissipating from the bath of heated oil in the coking oil container 18, the main body portion 12 also preferably has an exterior paneling 22 that surrounds the majority of its periphery and that is spaced from the cooking oil container so as to prevent persons working around the device from being exposed to excessive heat.

In addition to its basic components, the main body portion 12 of the potato chip manufacturing device 10 also comprises a support rack 24 for supporting and guiding the slicing mechanism 14 and an electronic control unit 26. The support rack preferably comprises three parallel guide rails 28, a threaded drive rod 30, an electromechanical drive rod motor 32, and a sensor support beam 34. The guide rails 28, the drive rod 30, and the sensor support beam 34 are oriented parallel to each other and are rigidly, but also removably, attached to the main body portion 12 in a manner such that they overhang slightly over one of the side exterior panels 22. The drive motor 32 supports one end of the drive rod 30 from the remainder of support rack 24 and is configured to rotationally spin the drive rod in response to electrical power. Three electromechanical sensors 36 are secured to the sensor support beam 34 along its length. The control unit 26 is operatively connected to each of the sensors 36, to the heat source beneath the cooking oil container 18, and to the drive rod motor 32.

Preferably, the entire main body portion 12 of the potato chip manufacturing device 10 further comprises four wheels 38. The four wheels 38 are each mounted for rotational movement to a different corner of the frame assembly of the main body portion 12. As such, the four wheels 38 are configured to support the entire potato chip production device 10 from a surface and to allow it to be easily translated or repositioned over such surface.

The slicing mechanism 14 preferably comprises a base member 40, wheels 42, potato holders 44, a blade member 46, and a blade drive motor 47. The base member 40 is configured and adapted to connect and support the other components of the slicing mechanism 14 and consists mainly of two rigid aluminum plate members 48 that are spaced apart parallel to each other and rigidly connected to each other via a plurality of column members 50. The blade member 46 is disc shaped and preferably comprises a plurality of blades in a manner similar to a food processor. The blade drive motor 47 is fixed to the bottom plate member 48 and is configured and adapted to rotationally drive the blade member 46 beneath the upper plate member. The potato holders 44 are similar to each other and each comprises a pair of opposed C-channel members 52 so as to form a generally rectangular slot 54 into which potatoes 56 can be stacked therein as shown. Each potato holder 44 also comprises a hinge 58 that allows the potato holder to be folded ninety degrees to facilitate the transportation of the potato chip production device 10. Finally, the wheels 42 preferably each have an outer annular V-groove and are mounted for rotation beneath the lower plate member 48.

The slicing mechanism 14 is preferably attached to the support rack 24 of the main body portion 12 of the potato chip production device 10 by its wheels 42 which ride along guide rails 28 of the support rack. The slicing mechanism 14 is also attached to the drive rod 30 of the support rack 24 in a manner such that the slicing member translates horizontally along the guide rails 28 in response to rotation of the drive rod. Additionally, the blade drive motor 47 is operatively connected to, and thereby controlled by, the electronic control unit 26.

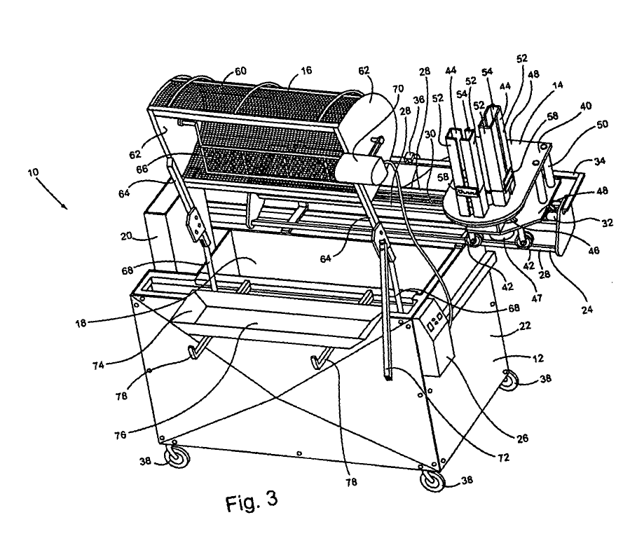

The strainer 16 preferably comprises a mesh or screen bin 60 having a semi-cylindrical bottom portion. The strainer 16 also preferably comprises opposed end walls 62, a pair of cantilevered support beams 64, a mesh mixing paddle 66 (shown only in FIG. 3), a pair of screw jacks 68, a mixing paddle drive motor 70, and a dumping lever 72. The mesh bin 60 has a dimension slightly smaller that that of the cooking oil container 18 such that is can be lowered at least partially thereinto. The end walls 62 partially bound the mesh bin 60 and maintain the shape of mesh. The mixing paddle 66 is positioned within the mesh bin and is rotationally connected to and extends between the end walls 62. The mixing paddle drive motor 70 is attached to one of the support beams 64 and is operatively connected to the mixing paddle 66 and the electronic control unit 26 for rotating the mixing paddle within the mesh bin 60. The support beams 64 are pivotally attached to the screw jacks 68 in a manner allowing the rest of the strainer 16 to pivot at least ninety degrees, as shown, relative to the screw jacks. The screw jacks 68 are positioned between the exterior paneling 22 and the cooking oil container 18 of the main body portion 12 of the potato chip production device 10 and attach the strainer 16 to the main body portion. Additionally, the screw jacks 68 are operatively connected to the electronic control unit 26 and are electromechanically driven so as to vertically extend and retract in a manner such that the mesh bin 60 can be raised out of and lowered into the cooking oil container 18. Finally, the dumping lever 72 is rigidly connected to one of the support beams 64 and cantilevers therefrom to provide a handle and lever-arm for manually pivoting the mesh bin 60 relative to the screw jacks 68.

In addition to the above mentioned components of the potato chip production device 10, the device may also include a potato chip collection assembly 74 as shown in FIG. 3. the potato chips collection assembly preferably comprises a collection tray 76 and two support arms 78. The support arms 78 are configured to be removably attachable to the main body portion 12 of the potato chip production device 10 in a manner such that they cantilever therefrom. The potato chip collection tray 76 is dimension to be at least as long as the mesh bin 60 and to be supported by the cantilevered support arms 78.

In operation, the potato chip device is operated by first heating the oil within the cooking oil container to an acceptable temperature. Such a temperature is well known in the art and may vary depending upon the type of oil used and the type and thickness of potato chips being produced. Preferably, an external portable propane tank provides fuel to the heat source for this purpose. While the heat source could be controlled by the electronic control unit, it is preferably controlled by a separate thermostat that monitors the temperature of the cooking oil.

Prior to activating the electronic control unit to being producing potato chips, raw potatoes a loaded into the slots of the potato holders on the slicing mechanism. The rectangular configuration of the slots allow the potatoes to be held with their longest dimension generally parallel to the blade member such that the chips being produced are as large as possible. During this step, the slicing mechanism is positioned at the cantilevered end of the support rack as shown in FIGS. 1 and 3.

With the above-mentioned steps performed, the electronic control unit can be activated to automatically produce deep-fried potato chips from the raw potatoes that have been loaded into the device. With the strainer lowered into in the cooking oil as shown in FIG. 1, the electronic control unit activates the drive rod motor of the support rack which causes the slicing mechanism to move toward the opposite end of the support rack. When the slicing mechanism is over the cooking oil bin, it triggers the middle sensor on the support rack which, via the electronic control unit, causes the blade drive motor to begin rotating the blade member. Gravity forces the raw potatoes into the spinning blade member which slices the raw potatoes into raw potato chips. As this occurs, the slicing mechanism continues translating relative to the support rack and eventually reaches the sensor at the opposite end from which it started. Upon receiving a signal from this sensor, the electronic control unit switches the direction of the drive rod motor and thus the direction of translation of the slicing mechanism. Eventually, the slicing mechanism once again triggers the middle sensor, which in response thereto, reverses the direction of the drive rod motor and hence, the slicing mechanism. This continues such that the slicing mechanism moves horizontally back and forth over the cooking oil container. After a preprogrammed amount of time or number of reciprocated passes, the blade drive motor is turned off and the slicing member is allowed to move back to its original loading position where the last sensor triggers the electronic control unit to shut off the drive rod motor.

It should be appreciate that while this slicing step occurs, the raw potato chips fall by gravity into the mesh bin of the strainer where they are immersed in the cooking oil. It should also be appreciated that the reciprocated movement of the slicing mechanism during this step causes the raw potato chips to fall in a dispersed manner so as to prevent them from sticking to each other during there first few moments of cooking.

During the slicing and during the cooking steps of production, the mixing paddle is rotationally driven by the mixing paddle drive motor and the electronic control unit. This, like the movement of the slicing mechanism, helps prevent the potato chips from sticking to each other during the cooking process.

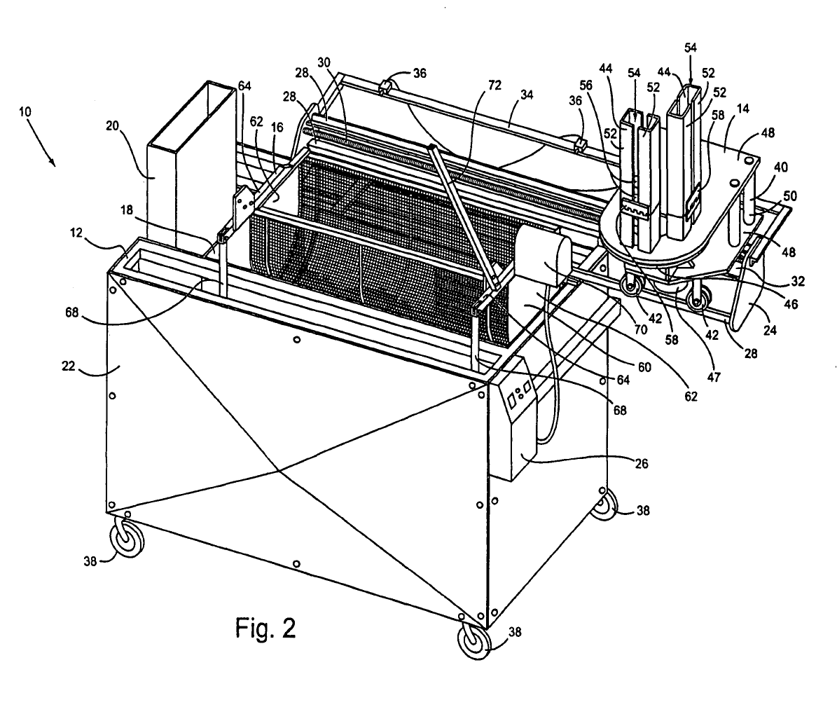

After a set amount of time has passed, the electronic control unit shuts off the mixing paddle drive motor and activates the screw jacks of the strainer. When activated, the screw jacks extend and thereby lift the mesh bin of the strainer out of the cooking oil as shown in FIGS. 2 and 3. This stops the cooking process. It should be appreciated that the determined amount of time is calculated based on the particular potato chips being produced or through trial and error such that it is sufficient to allow the heated cooking oil to covert the raw potato chips into deep-fried potato chips. It should further be appreciate that by moving the slicing member back to its original loading position, the slicing mechanism is no longer above the mesh bin where it would otherwise interfere with the raising thereof.

Once the mesh bin is fully raised, the control unit switches to a paused mode where all movable components remain stopped in their current positions. At this point and with the mesh bin raised and the potato chips removed from the cooking oil, the person operating the potato chip production device can then force the dumping lever of the strainer downward to thereby pivot the mesh bin about the connection between the screw jacks and the support beams of the strainer. As such, the mesh bin of the strainer pivots from the position shown in FIG. 2 to the position shown in FIG. 3. This allows the deep-fried potato chips to fall into the collection tray of the potato chip collection assembly in a waterfall like manner. If all of the chips do not fall freely, the rest can be removed from the mesh bin by a tool such as a spatula.

After the potato chips have been removed from the mesh bin and are positioned in the collection tray, seasoning is preferably added to the deep-fried potato chips. The application of such seasoning is facilitated by the collection tray configuration and the fact that the potato chips are removed from the mesh bin in manner such that they are distributed the full length of the mesh bin in the collection tray. In other words, as removed from the mesh bin, the potato chips are arranged in a generally narrow row and are not significantly piled on top of each other. This makes the seasoning process, which is preferably performed manually using a hand shaker, fairly simple and even. With the deep-fried potato chips seasoned, the potato chips are ready for consumption and the collection tray can be lifted from the support arms of the potato chip collection assembly and then the chips can be dumped therefrom into some other container from which individual servings of the chips can be obtained.

During the seasoning process or anytime after the removal of the potato chips from the mesh bin, the potato chip production device can be reloaded with raw potatoes and the control unit reactivated to begin the entire process over again. Upon reactivation, the control unit first lowers the strainer back into the bath of heated oil and then repeats the steps discussed above. Thus, the potato chip production device can be reactivated as many times as desired to produce as many batches of chips as desired.

Preferably, an operator of the potato chip production device produces potato chips at or near their point of sale or place of consumption. The operation of the potato chip production device at a fair, amusement park, or other type of setting will provide a marketing advantage over other food items for sale. In other words, operation of the production device in close proximity to the point of sale of the potato chips, entices people to purchase the chips.

The wheels mounted to the frame assembly of the main body of the production device allow the production device to be easily transported over the surface from which it is supported. This is beneficial in situations such as when the production device is utilized at fairs or other locations where it must be brought on site and removed relatively soon thereafter. To this end, the production device is dimensioned such that it can be loaded onto a standard full-size pickup truck bed or onto a small trailer for transportation to a different event at a different location.

It should be understood that all matter contained in the above description or shown in the accompanying drawings is intended to be interpreted as illustrative and not in a limiting sense and that various modifications and variations of the device and methods may be employed without departing from the scope of the invention defined by the following claims. For example, it should be appreciated that, although the heat source of the potato production device preferably operates via propane, the heat source could alternatively produce heat from any other source, such as electricity. Moreover, the display of particular production steps to a consumer, unless required by any particular claim, needs not necessarily be visible at the point of sale. Thus, other possible variations and modifications of the production device and its method of use should be appreciated.

Furthermore, it should be understood that when introducing elements of the present invention in the claims or in the above description of the preferred embodiment of the invention, the terms “comprising,” “including,” and “having” are intended to be open-ended and mean that there may be additional elements other than the listed elements. Similarly, to the extent the term “portion” is used in the claims or is added by amendment, such term should be construed as meaning some or all of the item or element that it qualifies.

1. A method comprising:
slicing at least one raw potato via a slicing mechanism into a plurality of raw potato chips above a volume of heated oil in a manner such that gravity causes the raw potato chips to fall into the heated oil;
converting the raw potato chips into deep-fried potato chips via the heated oil;
removing the deep-fried potato chips from the heated oil, the steps of slicing, converting, and removing being performed automatically and constituting production of deep-fried potato chips;
displaying the slicing and the removing steps to a potential consumer to entice the potential consumer to purchase deep-fried potato chips, the displaying being by direct line-of-sight; and
selling deep-fried potato chips to the consumer, the selling occurring within fifty feet of said production of deep-fried potato chips.

2. A method in accordance with claim 1 wherein the raw potato has a largest dimension that defines a longitudinal direction of the raw potato and wherein the production of deep-fried potato chips further comprises automatically feeding the at least one raw potato into the slicing mechanism in a manner such that the longitudinal direction of the at least one potato is oriented in a particular manner during the slicing of the at least one raw potato into the plurality of raw potato chips.

3. A method in accordance with claim 2 wherein the production of deep-fried potato chips further comprises automatically feeding the at least one raw potato into the slicing mechanism in a manner such that the slicing occurs parallel to a plane that is angled less than twenty degrees from the longitudinal direction of the raw potato during the slicing of the at least one raw potato into the plurality of raw potato chips.

4. A method in accordance with claim 1 wherein the steps of producing deep-fried potato chips, displaying the slicing and the removing steps to a potential consumer, and selling deep-fried potato chips to the consumer are performed via a portable potato chip production device located at a first location, the method further comprising transporting the portable potato chip production device from the first location to a second location that is at least one-half of a mile from the first location, the method further comprising repeating the steps of producing deep-fried potato chips, displaying the slicing and the removing steps to a potential consumer, and selling deep-fried potato chips to the consumer while the potato chip production device is located at the second location.

5. A method in accordance with claim 4 wherein the portable potato chip production device comprises at least two wheels that are configured and adapted to at least partially support the portable potato chip production device from a surface, the step of transporting the portable potato chip production device utilizing the two wheels.

6. A method in accordance with claim 1 wherein the step of producing the deep-fried potato chips further comprises horizontally translating the raw potato in a reciprocating manner above the volume of heated oil as the slicing of the raw potato occurs.

7. A method in accordance with claim 1 wherein the step of removing the deep-fried potato chips from the heated oil comprises automatically raising a strainer to effectuate the removal of the fried potato chips from the heated oil, the method further comprising rotating the strainer in a manner causing the deep-fried potato chips to fall by gravity from the strainer and onto a chip collection tray.

8. A method in accordance with claim 1 wherein the step of displaying the slicing and the removing steps to a potential consumer and the step of selling deep-fried potato chips to the consumer occur with the consumer being positioned at the same location during both of said steps.

9. A method comprising:
providing a deep-fried potato chip production device, the production device comprising a slicing mechanism, a bath of heated oil, a strainer, and an electronic control unit;
slicing a plurality of raw potatoes into a plurality of raw potato chips via the slicing mechanism, the slicing occurring over the bath of heated oil and while the slicing mechanism and the plurality of raw potatoes are moving in a reciprocating manner relative to the bath of heated oil such that gravity causes the plurality raw potato chips to fall into the bath of heated oil in a dispersed manner, the moving of the slicing mechanism and the slicing being controlled by the control unit;
converting the raw potato chips into deep-fried potato chips via the bath of heated oil; and
removing the deep-fried potato chips from the bath of heated oil by raising the strainer out of the bath of heated oil, the raising of the strainer being controlled by the control nit.

10. A method in accordance with claim 9 the method further comprising displaying the slicing and the removing steps to at least one potential consumer to entice the potential consumer to purchase deep-fried potato chips, the displaying being by direct line-of-sight, selling deep-fried potato chips to the consumer, the selling occurring within fifty feet of where the steps of slicing and removing occur.

11. A method in accordance with claim 9 wherein each of the raw potatoes has a largest dimension that defines a longitudinal direction of the respective raw potato and wherein the method further comprises automatically feeding the raw potatoes into the slicing mechanism in a manner such that the longitudinal direction of each respective potato is oriented in a particular manner during the slicing of the raw potatoes into the plurality of raw potato chips.

12. A method in accordance with claim 11 wherein the method further comprises automatically feeding the raw potatoes into the slicing mechanism in a manner such that the slicing of each potato occurs parallel to a plane that is angled less than twenty degrees from the longitudinal direction of the respective raw potato during the slicing of the raw potatoes into the plurality of raw potato chips.

13. A method in accordance with claim 9 wherein the step of slicing a plurality of raw potatoes into a plurality of raw potato chips further comprises moving the slicing mechanism and the plurality of raw potatoes back and forth along a reciprocating axis relative to the bath of heated oil, the method further comprising rotating the strainer about an axis that is parallel to the reciprocating axis in a manner causing the fried potato chips to fall by gravity from the strainer and onto a chip collection tray.

14. A method in accordance with claim 9 wherein the step of slicing a plurality of raw potatoes into a plurality of raw potato chips further comprises moving the slicing mechanism and the plurality of raw potatoes back and forth between first and second positions along a reciprocating axis relative to the bath of heated oil, the control unit controlling the number of times the slicing mechanism is moved back and forth between the first and second positions.

15. A method in accordance with claim 9 the method further comprising transporting the potato chip production device.

16. A method in accordance with claim 15 wherein the potato chip production device comprises at least two wheels that are configured and adapted to at least partially support the potato chip production device from a surface, the step of transporting the potato chip production device comprising the step of utilizing the two wheels.

17. An apparats comprising:
a cooking oil container containing a bath of cooking oil;
a heat source adapted to provide heat to the bath of cooking oil;
a potato slicing mechanism configured and adapted to slice raw potatoes, the potato slicing mechanism being operatively connected to the cooking oil container in a manner such that the potato slicing mechanism is capable of reciprocating movement relative to the bath of cooking oil;
a strainer operatively connected to the cooking oil container in a manner such that at least a portion of the strainer is movable into and out of the bath of cooking oil; and
an electronic control unit operatively connected to the potato slicing mechanism and the strainer in a manner such that the electronic control unit is adapted to control the reciprocating movement of the potato slicing mechanism and the movement of the portion of the strainer.

18. An apparatus in accordance with claim 17 wherein the potato slicing mechanism comprises a holder and a cutting blade, the holder being dimensioned to hold a plurality of raw potatoes, each of the raw potatoes having a largest dimension that defines a longitudinal direction of the respective raw potato, the holder also being adapted and configured to feed the raw potatoes into the cutting blade in a manner such that the longitudinal direction of each respective potato is oriented in a particular manner relative to the cutting blade of the potato slicing mechanism.

19. An apparatus in accordance with claim 17 wherein the apparatus further comprises a frame assembly and at least two wheels, the frame assembly being connected to the cooking oil container in a manner such that frame assembly supports the cooking oil container above a surface, the two wheels being connected to the frame and being positioned and adapted to at least partially support the frame assembly above the surface, the wheels being configured and adapted to facilitate translation of the apparatus along the surface.

20. An apparatus in accordance with claim 17 wherein the potato slicing mechanism is capable of reciprocating movement between first and second positions along a reciprocating axis relative to the bath of cooking oil and wherein the strainer is pivotal about a pivot axis that is parallel to the reciprocating axis.

21. An apparatus in accordance with claim 20 wherein the pivot axis is movable relative to the bath of cooking oil.

22. A method comprising:
proving an apparatus in accordance with claim 17;
slicing a plurality of raw potatoes into a plurality of raw potato chips via the potato slicing mechanism, the slicing occurring above the bath of cooking oil and while the potato slicing mechanism is moving in a reciprocating manner relative to the bath of cooking oil such that gravity causes the plurality raw potato chips to fall into the bath of cooking oil in a dispersed manner, the moving of the slicing mechanism and the slicing being controlled by the control unit;
converting the raw potato chips into deep-fried potato chips via the cooking oil; and
removing the deep-fried potato chips from the bath of cooling oil by raising the strainer at least partially out of the bath of cooking oil, the raising of the strainer being controlled by the control unit.

23. The method in accordance with claim 1 wherein the slicing, converting and removing steps are under the control of an electronic control unit.

24. The apparatus in accordance with 21 wherein the strainer is cantilevered on support beams and the pivot axis is parallel to a long axis of the strainer.

25. The apparatus in accordance with claim 24 wherein the support beams are pivotable about the pivot axis.

26. The apparatus in accordance with claim 25 wherein the support beams are pivoted to jack screws for raising and lowering the strainer into the bath of cooking oil.

27. The apparatus in accordance with claim 26 wherein a dumping lever is attached to at least one of the support arms for manually pivoting the strainer about the pivot axis.

28. The method in accordance with claim 22 wherein the potato slicing mechanism is held at a low angle to the bath of cooking oil such that the plurality of raw potato chips fall into the bath of cooking oil on edge, preventing stacking of the uncooked slices, and promoting even cooking.

29. The method in accordance with claim 22 wherein the converting of the raw potato chips into deep-fried potato chips via the cooking oil is controlled by the control unit.

30. The apparatus in accordance with claim 17 wherein the potato slicing mechanism holds a blade member at a low angle with respect to the cooking oil container.

31. The apparatus in accordance with claim 30 wherein there are potato holders on the potato slicing mechanism and the potatoes are held in the potato holders such that a long axis of the potatoes is parallel with the blade member to allow for proper and even slicing.

32. The apparatus in accordance with claim 17 wherein the strainer has a semi-cylindrical bottom portion and vertical end walls to allow for stirring with a single paddle and to reduce the amount of cooking oil needed, while still maintaining a large cooking area, as the potato chips are cooked in the top 2-3 inches of oil.

33. The apparatus in accordance with claim 32 wherein the strainer is cantilevered on support beams attached to the end walls of the strainer.

34. The apparatus in accordance with claim 33 wherein the support beams are pivotable about a pivot axis parallel to a long axis of the strainer.

35. The apparatus in accordance with claim 34 wherein the support beams are pivoted to jack screws for raising and lowering the strainer into the bath of cooking oil.

36. The apparatus in accordance with claim 34 wherein a dumping lever is attached to at least one of the support arms for manually pivoting the strainer about the pivot axis.

37. The apparatus in accordance with claim 35 wherein the jack screws are under control of the electronic control unit.
